(19) United States
(12) Patent Application Publication
(10) Pub. No.: US 2026/0117565 A1
(43) Pub. Date: Apr. 30, 2026

(54) INERTIA DEVICE FOR A VEHICLE LATCH

(71) Applicant: Inteva Products, LLC, Troy, MI (US)

(72) Inventors: Yoshihiko Tametani, Tokyo (JP); Donald Michael Perkins, Warren, MI (US); Jeevan Jayaprakash, Chitradurga (IN); Praveenkrishna Deva, Sullia Taluk (IN); Arun Murthy, Bengaluru (IN)

(21) Appl. No.: 19/003,753

(22) Filed: Dec. 27, 2024

(30) Foreign Application Priority Data
Dec. 28, 2023 (IN) 202311089326
Jun. 28, 2024 (IN) 202411049744

(51) Int. Cl. E05B 77/06

(52) U.S. Cl. CPC E05B 77/06

(57) ABSTRACT

An inertia device for a vehicle latch, including: an inertia lever movably mounted to the vehicle latch for movement between a first position and a second position; a clutch lever movably mounted to the vehicle latch for movement between a first position and a second position; and a spring operably coupled to the inertia lever and the clutch lever, the spring biasing the inertial lever into its first position and the clutch lever into its second position, the inertia lever when in the first position prevents the clutch lever from moving to its second position and the clutch lever prevents the inertia lever from moving from its second position to its first position when the clutch lever is in its second position and movement of the inertial lever from its first position to its second position allows the clutch lever to move from its first position to its second position.

### CROSS REFERENCE TO RELATED APPLICATIONS

This application claims the benefit of the following Indian Provisional Patent Applications 202311089326 filed on Dec. 28, 2023 and 202411049744 filed on Jun. 28, 2024, the entire contents each of which are incorporated herein by reference thereto.

### BACKGROUND

Various embodiments of the present disclosure relate to a vehicle latch and more particularly, a vehicle latch with an inertia device.

A vehicle frequently includes displaceable panels such as doors, hood, trunk lid, hatch and the like which are affixed for hinged, pivotal, sliding or movable engagement with a host vehicle body. Cooperating systems of latches and strikers are typically provided to ensure that such panels remain secured in their fully closed position when the panel is closed.

A door latch typically includes a claw that is pivoted between an unlatched position and a primary latched position when the door is closed to latch the door in the closed position. The claw is typically held in the primary latched position by a pawl that pivots between an engaged position and a disengaged position. The pawl is spring biased into the engaged position and thus, holds the claw in the primary latched position when in the engaged position and releases the claw when it is moved to the disengaged position so that the door can be opened.

The claw is pivoted to the primary latched position by a striker attached to, for example, an associated door jamb when the door is closed. Once in the primary latched position, the pawl engages the claw to ensure the assembly remains latched.

Accordingly, it is desirable to provide a latch assembly wherein the pawl is prevented from inadvertently being moved into a disengaged position.

### BRIEF DESCRIPTION

Disclosed is an inertia device for a vehicle latch, including: an inertia lever movably mounted to the vehicle latch for movement between a first position and a second position; a clutch lever movably mounted to the vehicle latch for movement between a first position and a second position; and a spring operably coupled to the inertia lever and the clutch lever, the spring biasing the inertial lever into its first position and the clutch lever into its second position, the inertia lever when in the first position prevents the clutch lever from moving to its second position and the clutch lever prevents the inertia lever from moving from its second position to its first position when the clutch lever is in its second position and movement of the inertial lever from its first position to its second position allows the clutch lever to move from its first position to its second position.

In addition to one or more of the features described above, or as an alternative to any of the foregoing embodiments, the clutch lever has a first step portion for contacting a post of the inertia lever in order to retain the inertia lever in the first position.

In addition to one or more of the features described above, or as an alternative to any of the foregoing embodiments, the clutch lever has a second step portion for contacting the post of the inertia lever in order to retain the inertia lever in its second position.

Also disclosed is a vehicle latch, including: an outside release lever movably mounted to a housing of the vehicle latch for movement between a first position and a second position, the second position of the outside release lever causing the vehicle latch to be in an unlatched condition; an inertia device, the inertia device preventing undesired movement of the outside release lever from its first position to its second position, the inertia device including: an inertia lever movably mounted to the housing for movement between a first position and a second position, the second position of the inertia lever preventing inadvertent movement of the outside release lever from its first position to its second position and the first position of the inertia lever allowing for desired movement of the outside release lever from its first position to its second position; a clutch lever movably mounted to the housing for movement between a first position and a second position; and a spring operably coupled to the inertia lever and the clutch lever, the spring biasing the inertial lever into its first position and the clutch lever into its second position, the inertia lever when in the first position prevents the clutch lever from moving to its second position from its first position and the clutch lever prevents the inertia lever from moving from its second position to its first position when the clutch lever is in its second position and movement of the inertial lever from its first position to its second position allows the clutch lever to move from its first position to its second position.

In addition to one or more of the features described above, or as an alternative to any of the foregoing embodiments, the clutch lever has a first step portion for contacting a post of the inertia lever in order to retain the inertia lever in the first position.

In addition to one or more of the features described above, or as an alternative to any of the foregoing embodiments, the clutch lever has a second step portion for contacting the post of the inertia lever in order to retain the inertia lever in its second position.

In addition to one or more of the features described above, or as an alternative to any of the foregoing embodiments, the inertia lever has a pin slidably received within an opening of the outside release lever.

In addition to one or more of the features described above, or as an alternative to any of the foregoing embodiments, the opening of the outside release lever has a first portion and a second portion, the first portion being connected to the second portion by a connecting portion, wherein movement of the inertia lever from its first position to its second position causes the pin to slide within the connecting portion of the opening.

In addition to one or more of the features described above, or as an alternative to any of the foregoing embodiments, the first portion extends further from the connecting portion than the second portion and the first portion is an elongated opening configured to allow the pin to slid therein as the outside release lever from its first position to its second position.

In addition to one or more of the features described above, or as an alternative to any of the foregoing embodiments, movement of the outside release lever from its first position to its second position is caused by actuation of an outside lever operably coupled to the outside release lever.

In addition to one or more of the features described above, or as an alternative to any of the foregoing embodiments, the clutch lever has a first step portion for contacting a post of the inertia lever in order to retain the inertia lever in the first position.

In addition to one or more of the features described above, or as an alternative to any of the foregoing embodiments, the clutch lever has a second step portion for contacting the post of the inertia lever in order to retain the inertia lever in its second position.

In addition to one or more of the features described above, or as an alternative to any of the foregoing embodiments, the outside release lever has a cam surface that makes contact with the clutch lever when the clutch lever is in its second position and the outside release lever is moved from its first position to its second position.

In addition to one or more of the features described above, or as an alternative to any of the foregoing embodiments, the outside release lever is spring biased into its first position by a spring.

In addition to one or more of the features described above, or as an alternative to any of the foregoing embodiments, the outside release lever has a cam surface that makes contact with the clutch lever when the clutch lever is in its second position and the outside release lever is moved from its first position to its second position.

In addition to one or more of the features described above, or as an alternative to any of the foregoing embodiments, the outside release lever is spring biased into its first position by a spring.

In addition to one or more of the features described above, or as an alternative to any of the foregoing embodiments, the inertia lever has a stud pivotally mounted to a bushing of the housing and the clutch lever is rotationally mounted to a post of the housing.

In addition to one or more of the features described above, or as an alternative to any of the foregoing embodiments, the outside release lever is spring biased into its first position by a spring.

Also disclosed is a method for preventing inadvertent actuation of a vehicle latch, including: preventing an outside release lever movably mounted to a housing of the vehicle latch from moving from a first position to a second position, with an inertia device, the inertia device including: an inertia lever movably mounted to the housing for movement between a first position and a second position, the second position of the inertia lever preventing inadvertent movement of the outside release lever from its first position to its second position and the first position of the inertia lever allowing for desired movement of the outside release lever from its first position to its second position; a clutch lever movably mounted to the housing for movement between a first position and a second position; and a spring operably coupled to the inertia lever and the clutch lever, the spring biasing the inertial lever into its first position and the clutch lever into its second position, the inertia lever when in the first position prevents the clutch lever from moving to its second position from its first position and the clutch lever prevents the inertia lever from moving from its second position to its first position when the clutch lever is in its second position and movement of the inertial lever from its first position to its second position allows the clutch lever to move from its first position to its second position.

In addition to one or more of the features described above, or as an alternative to any of the foregoing embodiments, the method includes slidably mounting a pin of the inertia lever in an opening of the outside release lever, the opening having a first portion and a second portion, the first portion being connected to the second portion by a connecting portion, wherein movement of the inertia lever from its first position to its second position causes the pin to slide within the connecting portion of the opening.

### BRIEF DESCRIPTION OF THE DRAWINGS

The following descriptions should not be considered limiting in any way. With reference to the accompanying drawings, like elements are numbered alike:

FIG. 1 is a perspective view of a portion of a vehicle latch in accordance with the present disclosure with a cover removed;

FIG. 2 is a top view of a portion of a vehicle latch in accordance with the present disclosure with a cover removed;

FIG. 3 is a bottom view of a portion of the vehicle illustrating the claw and pawl;

FIG. 4 illustrates components of the vehicle latch;

FIGS. 5-12A illustrate operation of an inertia device for a vehicle latch in accordance with the present disclosure;

FIG. 13 is a perspective view of a portion of a vehicle latch in accordance with another embodiment of the present disclosure with a cover removed;

FIG. 14 is a top view of a portion of a vehicle latch in accordance with the embodiment illustrated in FIG. 13 with a cover removed;

FIG. 15 is a bottom view of a portion of the vehicle illustrating the claw and pawl;

FIG. 16 illustrates components of the inertia device in accordance with the embodiment of FIGS. 13 and 14; and

FIGS. 17-24A illustrate operation of an inertia device for a vehicle latch in accordance with the embodiment of FIGS. 13 and 14.

### DETAILED DESCRIPTION

A detailed description of one or more embodiments of the disclosed apparatus and method are presented herein by way of exemplification and not limitation with reference to the Figures.

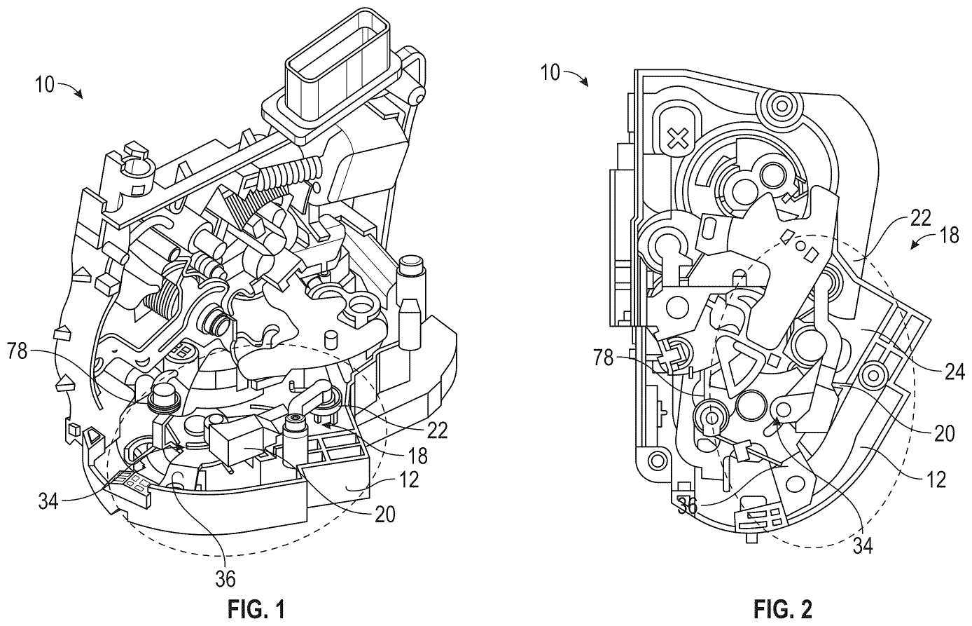

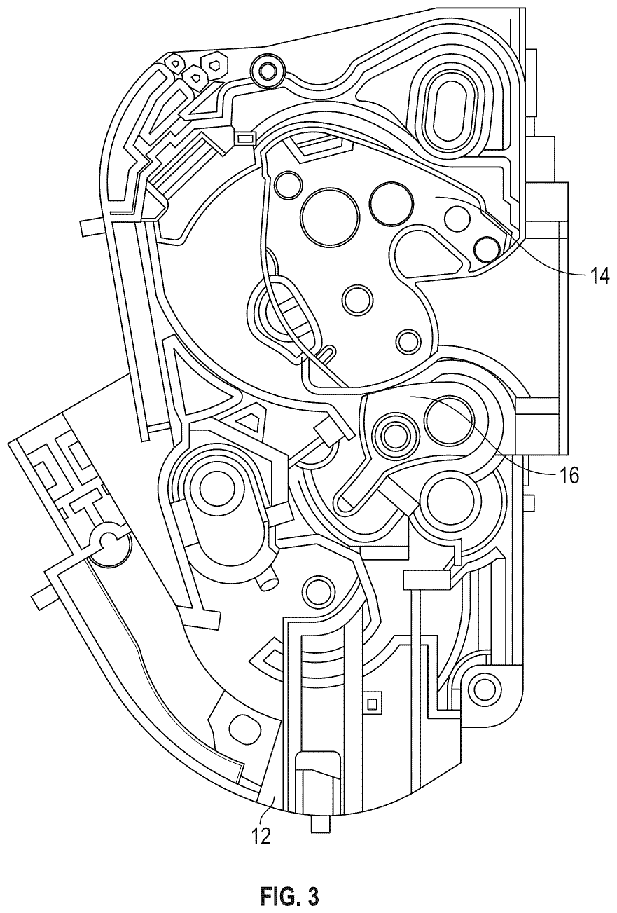

FIG. 1 is a perspective view of a portion of a vehicle latch or latch 10 with a cover removed. FIG. 2 is a top view of the portion of the vehicle latch 10 with a cover removed. The vehicle latch 10 has a housing 12. As illustrated in FIG. 3 a claw 14 is pivotally mounted to the housing 12 for movement between an unlatched position and a primary latched position. The claw when in the primary position engages a striker secured to a portion of the vehicle. The claw 14 is held in the primary latched position by a pawl 16 that is also pivotally mounted to the housing 12. The pawl pivots between an engaged position and a disengaged position. The pawl 16 is spring biased into the engaged position and thus, holds the claw 14 in the primary latched position when in the engaged position and releases the claw 14 when it is moved to the disengaged position so that the door can be opened.

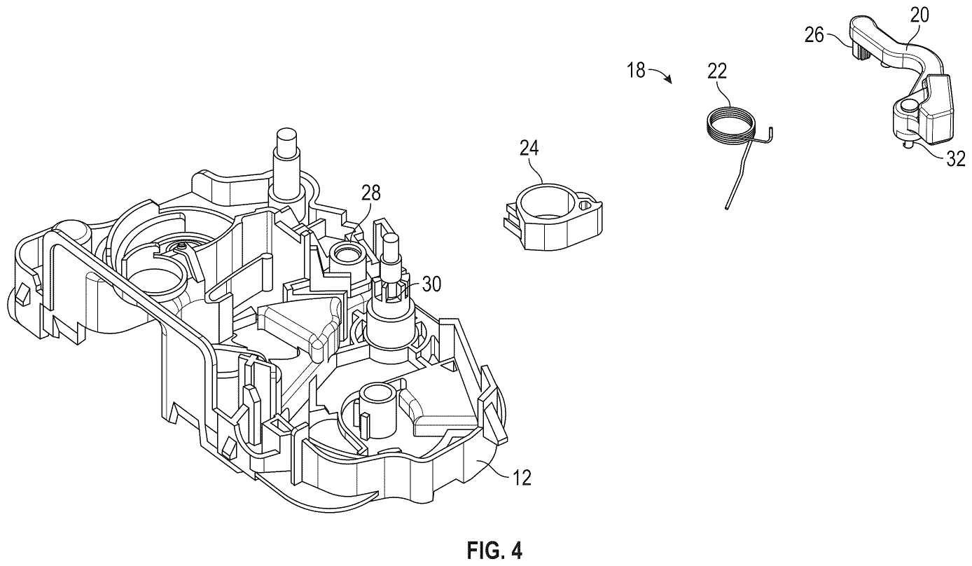

FIG. 4 illustrates the latch housing 12 and components of an inertia device 18. The inertia device 18 includes an inertia lever 20, an inertia spring 22 and a clutch lever 24. The inertia lever 20 is pivotally mounted to the housing 12. The clutch lever 24 is also pivotally mounted to the housing 12. The inertia spring 22 provides a biasing force to both the clutch lever 24 and the inertia lever 20. As such, only a single spring is required to provide the desired movement of the clutch lever 24 and the inertia lever 20. The inertia lever 20 has a stud 26 pivotally mounted to a bushing 28 of the housing 12. The clutch lever 24 is pivotally or rotationally mounted to a stud or post 30 of the housing 12.

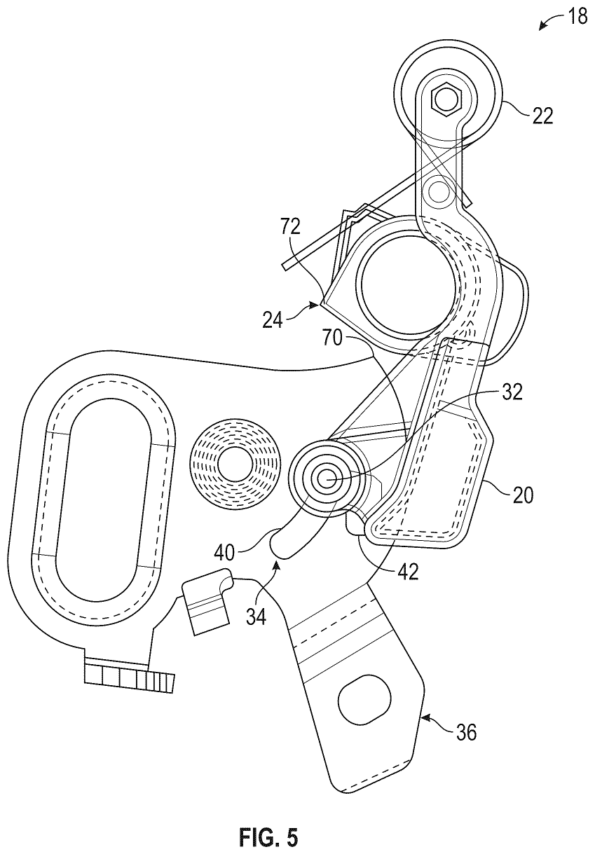

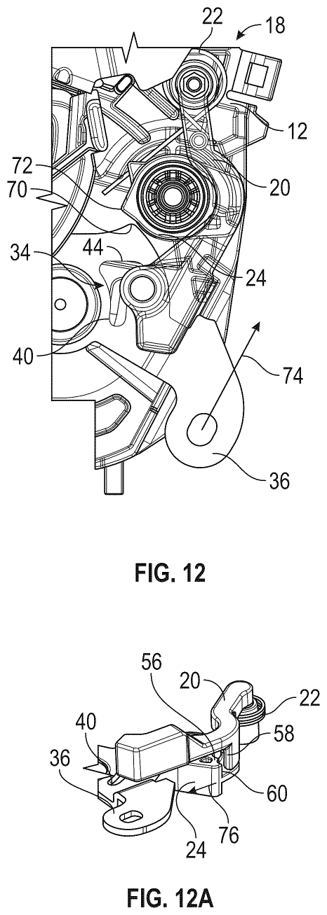

Referring now to FIGS. 5-12A, operation of the inertia device 18 in accordance with the present disclosure is illustrated. The inertia lever 20 also has a pin 32 that is slidably received within an opening 34 of an outside release lever 36. The outside release lever 36 is also pivotally mounted to the housing 12. The outside release lever 36 is also operably coupled to the pawl 16 such that movement of the outside release lever 36 from a first position illustrated in at least FIGS. 1, 2, 5 and 6 to a second position will move the pawl 16 from the engaged position where the pawl 16 prevents movement of the claw 14 from the primary latched position to the unlatched position where a striker can be released from the claw 14 and the latch 10. As will be discussed herein, the inertia device 18 is configured to prevent undesired movement of an outsider release lever of the vehicle latch 10.

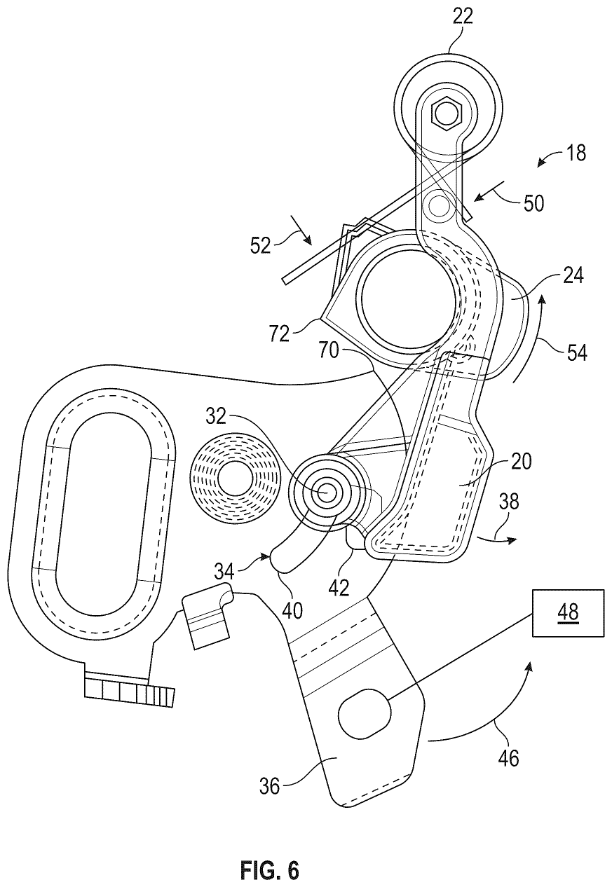

During an unexpected event (e.g., sudden deceleration or crash) a force is applied to the inertia lever 20 causing movement of the inertial lever 20 from a first position (illustrated in FIG. 6) in the direction of arrow 38 to a second position illustrated in at least FIG. 11. This causes movement of the inertia lever pin 32 in opening 34. As illustrated, opening 34 has first portion 40 and a second portion 42, the first portion 40 is connected to the second portion 42 by a connecting portion 44. Movement of the inertia lever 20 from its first position to its second position causes pin 32 to slide within connecting portion 44 of opening 34.

As illustrated, the first portion 40 is an elongated opening configured to allow the pin 32 to slid therein as the outside release lever 36 moves in the direction of arrow 46 from its first position to its second position and back again to the first position. Movement of the outside release lever 36 in the direction of arrow 46 is caused by actuation of an outside lever 48 (illustrated schematically) operably coupled to the outside release lever 36 by for example, a cable or any other equivalent device. The first portion 40 is configured to allow actuation of the outside release lever 36 by the outside lever 48 and as mentioned above actuation of the outside release lever 36 will cause movement of the pawl 16 from the engaged position to the disengaged position thereby allowing the claw 14 to release the striker.

When the inertia lever 20 is in the first position illustrated in FIG. 6, movement of the outside release lever 36 in the direction of arrow 46 is possible, which in turn allows the outside release lever 36 move the pawl 16 from the engaged position to the disengaged position so that latch 10 can be released from a striker.

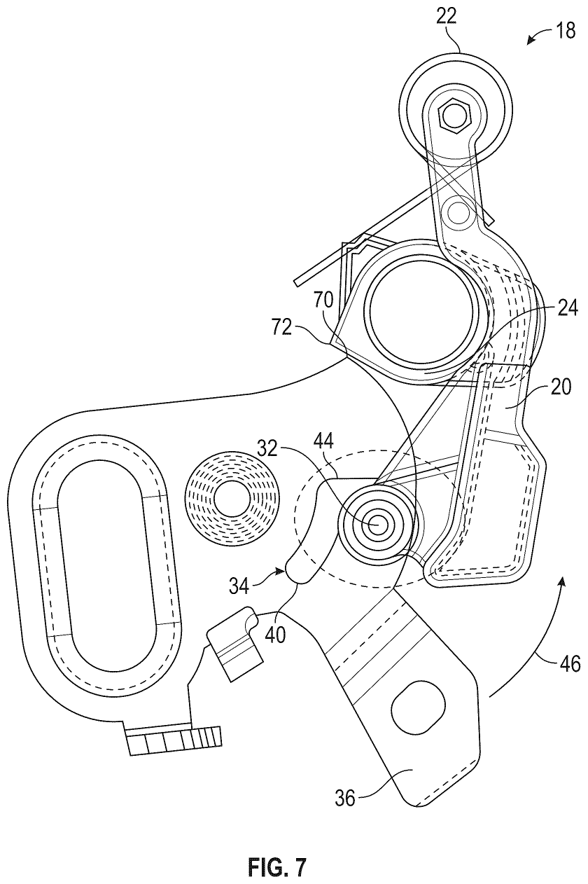

If however, the latch 10 subjected to an excessive force that could potentially cause rotational movement of the outside release lever 36 in the direction of arrow 46, which is not attributable to actuation of the outside lever 48 and thus not desired, the inertial lever 20 will move in the direction of arrow 38, which when the outside release lever 36 is in its first position illustrated in FIG. 6 and the inertial lever 20 moves from its first position to its second position, pin 32 will move generally in the direction of arrow 38 in connecting portion 44 of opening 34. As such and when the inertia lever 20 is in its second position, the pin 32 is now aligned with second portion 42 of opening 34 such that rotational movement of the outside release lever 36 in the direction of arrow 46 now causes pin 32 to travel in the second portion 42 of opening 34 as opposed to the first portion 40 of opening 34. This movement is illustrated in at least FIG. 7.

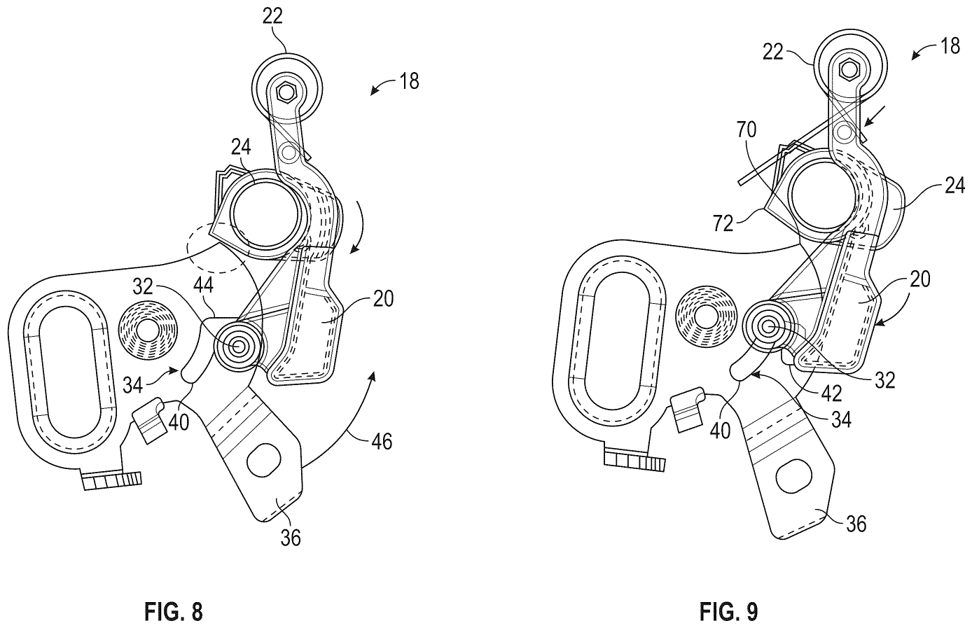

As illustrated in at least FIGS. 5-12, the first portion 40 of opening 34 is longer than the second portion 42 of opening 34 or in other words, the first portion 40 of opening 34 extends further from the connecting portion 44 than the second portion 42. Thus, movement of the pin 32 in the second portion 42 of opening 34 provides a limit of travel for the outside release lever 36 in the direction of arrow 46. This limit of travel is illustrated in at least FIG. 7. This limit of travel of release lever 36 prevents the outside release lever 36 from inadvertently moving the pawl 16 from the engaged position to the disengaged position. In other words, rotational movement of the outside release lever 36 in the direction of arrow 46 to the positions illustrated in FIGS. 7 and 8 is not sufficient enough to cause movement of the pawl from the engaged position to the disengaged position. Moreover, the pin 32 when reaching the end of second portion 42 of opening 34 will contact a side of the second portion 42 of the opening 34 which would require additional forces to continue the rotation of the outside release lever 36 in the direction of arrow 46.

Still further and as will be discussed below, the outside release lever 36 when traveling in the direction of arrow 46 and with the inertia lever 20 in its second position, the outside release lever 36 will eventually make contact with the clutch lever 24 further inhibiting unintended or undesired movement of the outside release lever 36 in the direction of arrow 46. The aforementioned contact of the pin 32 with a side of the second portion 42 of the opening 34 and/or the outside release lever 36 with the inertia lever 20 will occur before the outside release lever reaches its second position which causes the pawl 16 to move from its engaged position to its disengaged position.

Referring back now to FIG. 6, the inertia lever spring 22 provides a biasing force to the inertia lever 20 in the direction of arrow 50 and an opposite end of the initial lever spring 22 provides a biasing force to the clutch lever 24 in the direction of arrow 52. As such, and when the biasing force in the direction of arrow 50 is overcome due to a force applied to inertia lever 20, the inertia lever 20 moves in the direction of arrow 38 from its first position to its second position and the biasing force in the direction of arrow 52 causes the clutch lever 24 to move in the direction of arrow 54 from a first position illustrated in at least FIGS. 5, 6, 7 and 8 to a second position illustrated in at least FIGS. 7, 8 and 11.

This movement causes a first step feature 56 of clutch lever 24 to no longer engage a post 58 of inertia lever 20 which allows for rotational movement of the clutch lever 24 in direction of arrow 52 (e.g., from its first position to its second position). As the clutch lever 24 moves in the direction of 52 and the inertia lever 20 moves in the direction of arrow 38 (e.g., from its first position to its second position), post 58 is now engaged by a second step feature 60 of the clutch lever 24. The second step feature 60 of the clutch lever 24 will maintain the inertial lever 20 in the position illustrated in at least FIGS. 11 and 11A (e.g., the second position of the inertial lever 20), which is caused by the clutch lever also being in its second position.

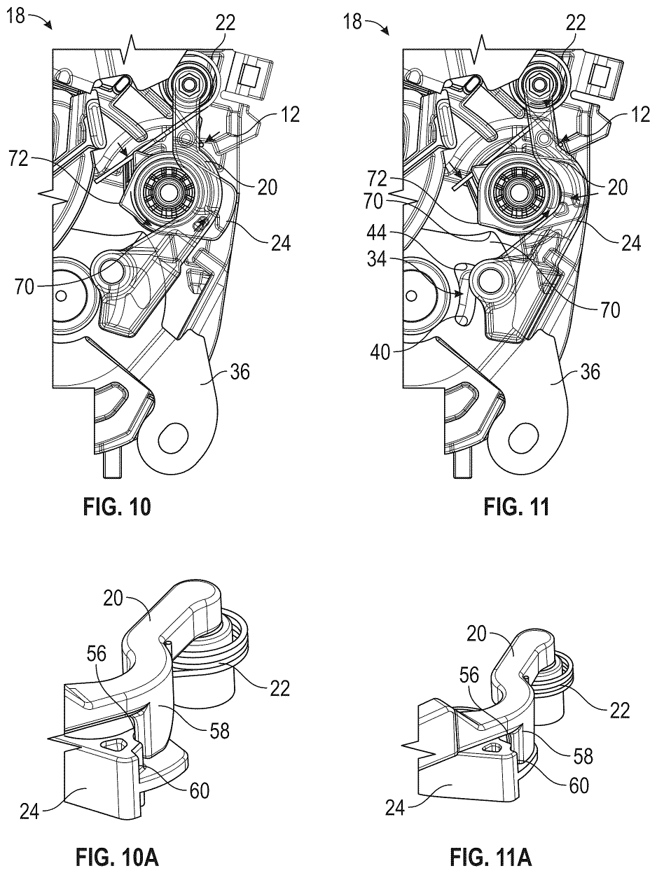

As such, and when the inertia lever 20 is in this position and the outside release lever 36 is moved in the direction of arrow 46, pin 32 will travel in the second portion 42 of opening 34. See also FIGS. 10-11A. Once the inertia lever 20 is in the position illustrated in at least FIGS. 11, 11A, this may be referred to as a clutched position of the inertia device 18. In this clutched position pin 32 will be in the position illustrated in at least FIGS. 11 and 11A, such that rotational movement of the outside release lever 36 in the direction of arrow 46 will cause pin 32 to travel in the shorter second portion 42 of opening 34 thereby preventing inadvertent release of the vehicle latch 10.

In order to reset the inertia device 18 and move the clutch lever 24 back to the position illustrated in at least FIG. 6 (e.g., its first position), a cam surface or feature 70 of the outside release lever makes contact with a cam surface or feature 72 of the clutch lever 24 in order to rotate the clutch lever 24 back to its first position. This contact is illustrated in at least FIGS. 7, 8 and 12, and is caused by application of a force to the outside release lever 36 in the direction of arrow 74, which is facilitated by operation of the outside lever 48. During this movement the clutch lever 24 is rotated in a direction opposite to arrow 52 such that the first step portion 56 and the second step portion 60 are moved away from post 58 in the direction of arrow 76 and spring 22 provides a biasing force to the inertia level 20 in the direction of arrow 50 so that the inertia lever 20 moves in a direction opposite to arrow 38 which then causes first step feature 56 to engage post 58 when the application of the force in the direction of arrow 74 is no longer applied to the outside release lever 36 and the outside release lever moves back to its first position, which is illustrated in at least FIG. 5. The outside release lever 36 being spring biased into its first position by for example a spring 78.

Thus, the inertia device 18 is reset and the outside release lever 36 is in its first position illustrated in at least FIGS. 1, 2, 5 and 6. In these positions, the inertia device 18 is reset and the outside release lever 36 is in its first position and operation and release of the vehicle latch 10 through intended movement of the outside release lever 36 is possible and the inertia device 18 is also reset and capable of preventing inadvertent release of the vehicle latch through unintended movement of the outside release lever 36.

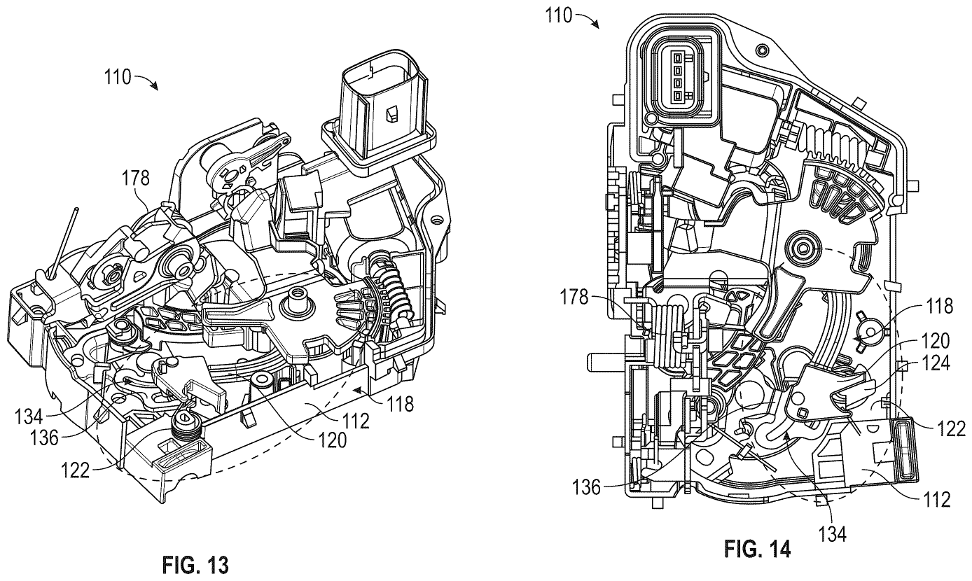

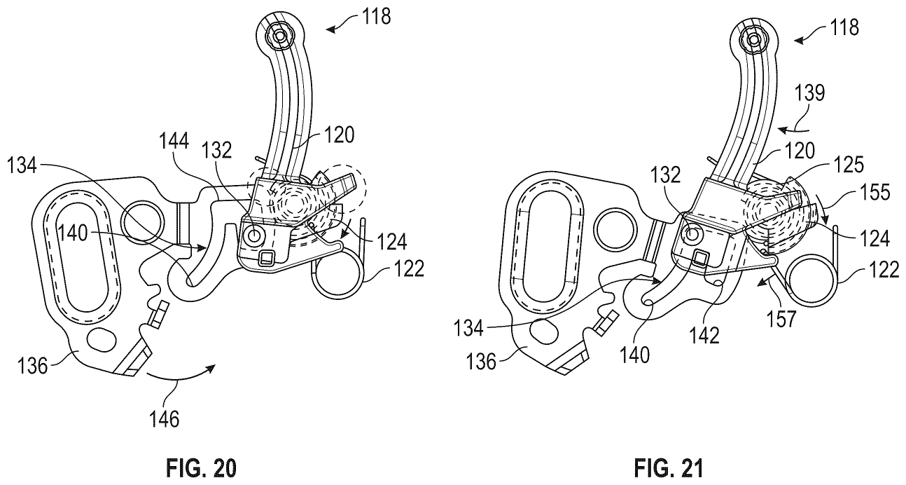

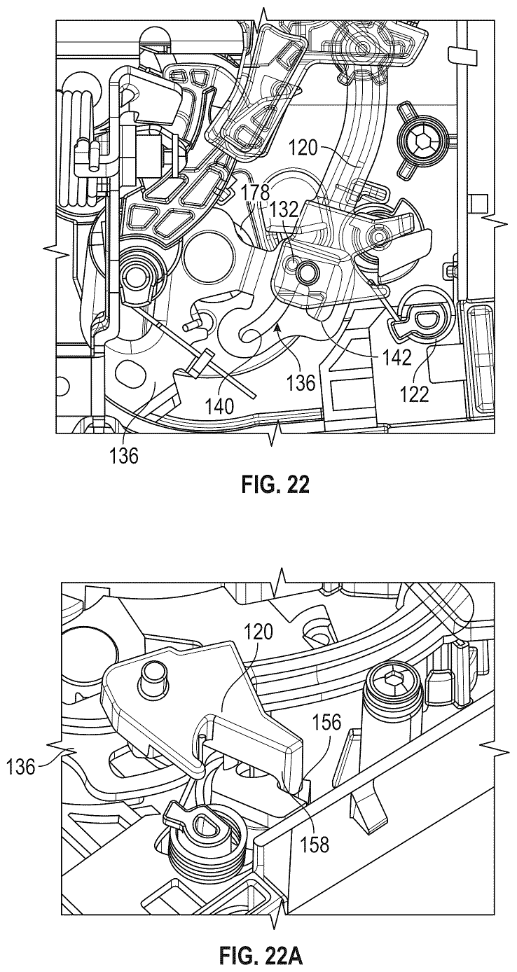

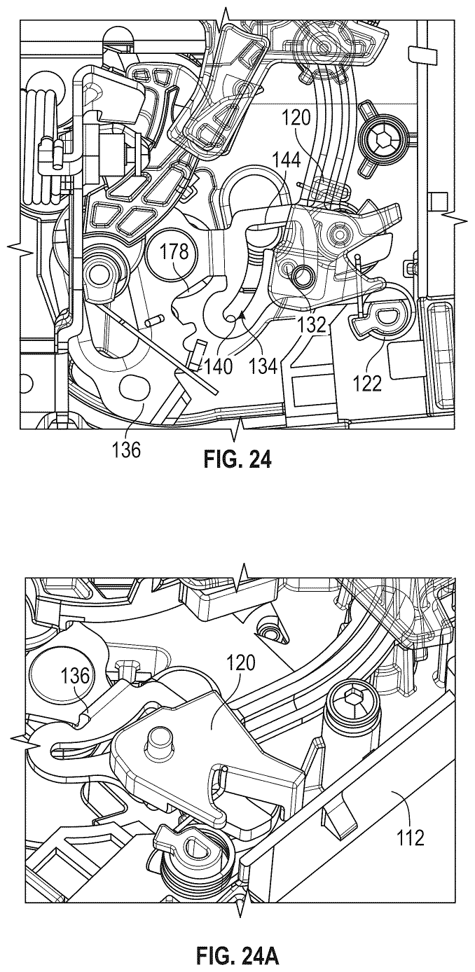

Referring now to FIGS. 13-24A, an alternative embodiment of the present disclosure is illustrated.

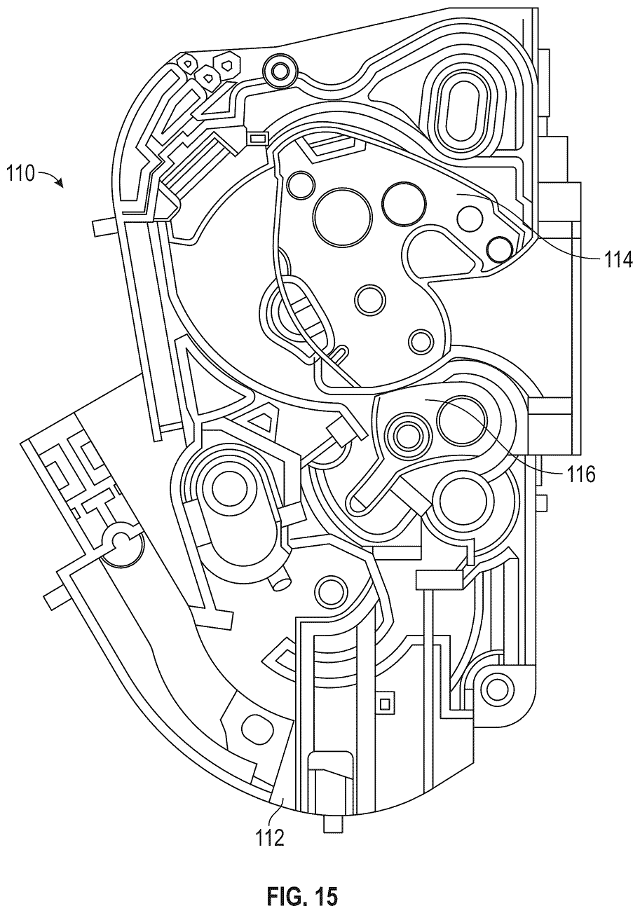

FIG. 13 is a perspective view of a portion of a vehicle latch or latch 110 with a cover removed. FIG. 14 is a top view of the portion of the vehicle latch 110 with a cover removed. The vehicle latch 110 has a housing 112. As illustrated in FIG. 15, a claw 114 is pivotally mounted to the housing 112 for movement between an unlatched position and a primary latched position. The claw when in the primary position engages a striker secured to a portion of the vehicle. The claw 114 is held in the primary latched position by a pawl 116 that is also pivotally mounted to the housing 112. The pawl 116 pivots between an engaged position and a disengaged position. The pawl 116 is spring biased into the engaged position and thus, holds the claw 114 in the primary latched position when in the engaged position and releases the claw 114 when it is moved to the disengaged position so that the door can be opened.

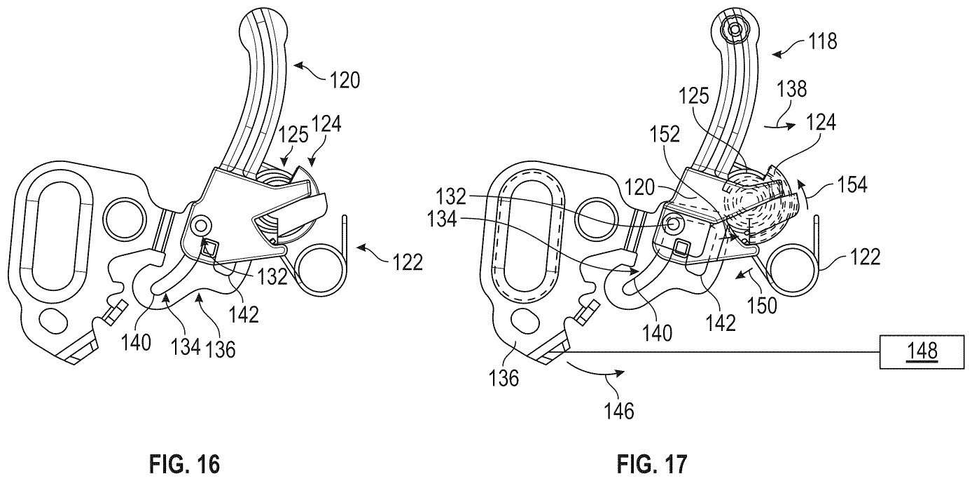

FIG. 16 illustrates components of an inertia device 118. The inertia device 118 includes an inertia lever 120, an inertia lever spring 122 and a clutch lever 124. The inertia lever 120 is pivotally mounted to the housing 112. The clutch lever 124 is also pivotally mounted to the housing 112. The inertia lever spring 122 provides a biasing force to the inertia lever 120 while a clutch lever spring 125 provides a biasing force to the clutch lever 124.

Referring now to FIGS. 17-24A, operation of the inertia device 118 in accordance with the present disclosure is illustrated. The inertia lever 120 also has a pin 132 that is slidably received within an opening 134 of an outside release lever 136. The outside release lever 136 is also pivotally mounted to the housing 112. The outside release lever 136 is also operably coupled to the pawl 116 such that movement of the outside release lever 136 from a first position illustrated in at least FIGS. 13, 14, 16 and 17 to a second position will move the pawl 116 from the engaged position where the pawl 116 prevents movement of the claw 114 from the primary latched position to the unlatched position where a striker can be released from the claw 114 and the latch 110. As will be discussed herein, the inertia device 118 is configured to prevent undesired movement of an outsider release lever of the vehicle latch 110.

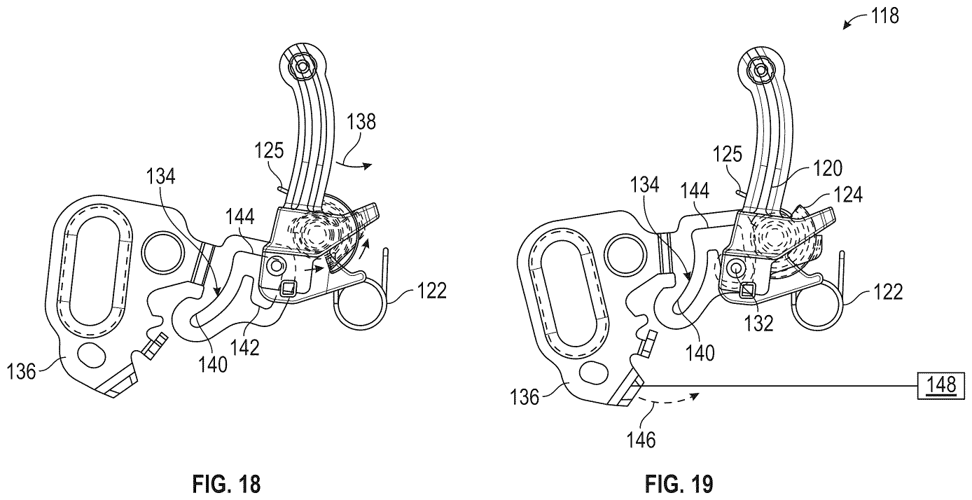

During an unexpected event (e.g., sudden deceleration or crash) a force may be applied to the inertia lever 120 causing movement of the inertial lever 120 from a first position (illustrated in FIG. 16) in the direction of arrow 138 to a second position illustrated in at least FIG. 18. This causes movement of the inertia lever pin 132 in opening 134. As illustrated, opening 134 has first portion 140 and a second portion 142, the first portion 140 is connected to the second portion 142 by a connecting portion 144. Movement of the inertia lever 120 from its first position to its second position causes pin 132 to slide within connecting portion 144 of opening 134.

As illustrated, the first portion 140 is an elongated opening configured to allow the pin 132 to slid therein as the outside release lever 136 moves in the direction of arrow 146 from its first position to its second position and back again to the first position. Movement of the outside release lever 136 in the direction of arrow 146 is caused by actuation of an outside lever 148 (illustrated schematically) operably coupled to the outside release lever 136 by for example, a cable or any other equivalent device. The first portion 140 is configured to allow actuation of the outside release lever 136 by the outside lever 148 and as mentioned above actuation of the outside release lever 136 will cause movement of the pawl 116 from the engaged position to the disengaged position thereby allowing the claw 114 to release the striker.

When the inertia lever 120 is in the first position illustrated in FIG. 17, movement of the outside release lever 136 in the direction of arrow 146 is possible, which in turn allows the outside release lever 136 move the pawl 116 from the engaged position to the disengaged position so that latch 110 can be released from a striker.

If however, the latch 110 subjected to an excessive force that could potentially cause rotational movement of the outside release lever 136 in the direction of arrow 146, which is not attributable to actuation of the outside lever 148 and thus not desired, the inertial lever 120 will move in the direction of arrow 138, which when the outside release lever 136 is in its first position illustrated in FIG. 17 and the inertial lever 120 moves from its first position to its second position, pin 132 will move generally in the direction of arrow 138 in connecting portion 144 of opening 134. As such and when the inertia lever 120 is in its second position, the pin 132 is now aligned with second portion 142 of opening 134 such that rotational movement of the outside release lever 136 in the direction of arrow 146 now causes pin 132 to travel in the second portion 142 of opening 134 as opposed to the first portion 140 of opening 134. This movement is illustrated in at least FIG. 18.

As illustrated in at least FIGS. 17-21, the first portion 140 of opening 134 is longer than the second portion 142 of opening 134 or in other words, the first portion 140 of opening 134 extends further from the connecting portion 144 than the second portion 142. Thus, movement of the pin 132 in the second portion 142 of opening 134 provides a limit of travel for the outside release lever 136 in the direction of arrow 146. This limit of travel is illustrated in at least FIG. 19. This limit of travel of release lever 136 prevents the outside release lever 136 from inadvertently moving the pawl 116 from the engaged position to the disengaged position. In other words, rotational movement of the outside release lever 136 in the direction of arrow 146 to the position illustrated in FIG. 19 is not sufficient enough to cause movement of the pawl from the engaged position to the disengaged position. Moreover, the pin 132 when reaching the end of second portion 142 of opening 134 will contact a side of the second portion 142 of the opening 134 which would require additional forces to continue the rotation of the outside release lever 136 in the direction of arrow 146.

Still further and as will be discussed below, the outside release lever 136 when traveling in the direction of arrow 146 and with the inertia lever 120 in its second position, the outside release lever 136 will eventually make contact with the clutch lever 124 further inhibiting unintended or undesired movement of the outside release lever 136 in the direction of arrow 146. The aforementioned contact of the pin 132 with a side of the second portion 142 of the opening 134 and/or the outside release lever 136 with the inertia lever 120 will occur before the outside release lever reaches its second position which causes the pawl 116 to move from its engaged position to its disengaged position.

Referring back now to FIG. 17, the inertia lever spring 122 provides a biasing force to the inertia lever 120 in the direction of arrow 150 and the clutch lever spring 125 provides a biasing force to the clutch lever 124 in the direction of arrow 152. As such, and when the biasing force in the direction of arrow 150 is overcome due to a force applied to inertia lever 120, the inertia lever 120 moves in the direction of arrow 138 from its first position to its second position and the biasing force in the direction of arrow 152 causes the clutch lever 124 to move in the direction of arrow 154 from a first position illustrated in at least FIGS. 16, 17 to a second position illustrated in at least FIG. 18.

This movement causes a first step feature 156 of clutch lever 124 to engage a post 158 of inertia lever 120 which allows for rotational movement of the clutch lever 124 in direction of arrow 154 (e.g., from its first position to its second position). As the clutch lever 124 moves in the direction of 154 and the inertia lever 120 moves in the direction of arrow 138 (e.g., from its first position to its second position).

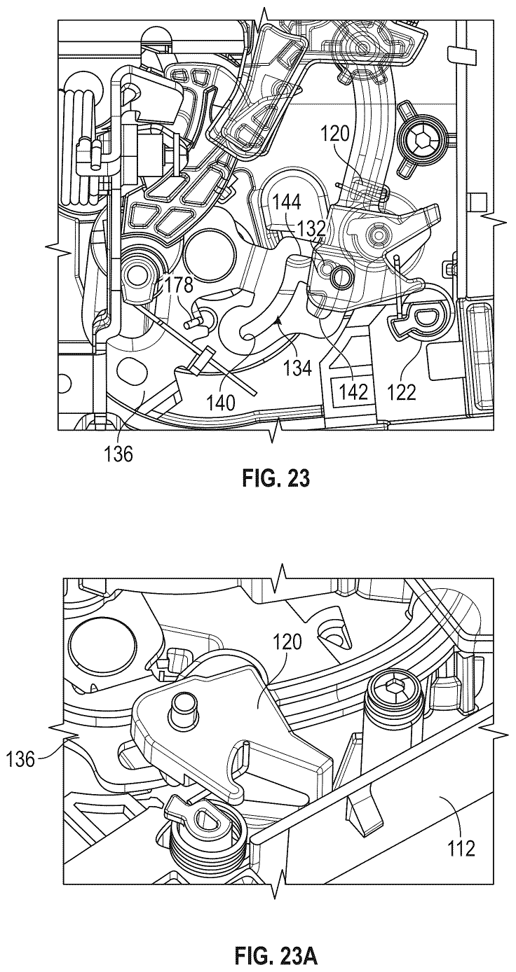

As such, and when the inertia lever 120 is in the position illustrated in FIG. 18, and the outside release lever 136 is moved in the direction of arrow 46, pin 132 will travel in the second portion 142 of opening 134. See also FIGS. 23-23A. Once the inertia lever 120 is in the position illustrated in at least FIGS. 23, 23A, this may be referred to as a clutched position of the inertia device 118. In this clutched position pin 132 will be in the position illustrated in at least FIGS. 23 and 23A, such that rotational movement of the outside release lever 136 in the direction of arrow 146 will cause pin 132 to travel in the shorter second portion 142 of opening 134 thereby preventing inadvertent release of the vehicle latch 110.

In order to reset the inertia device 118 and move the clutch lever 124 back to the position illustrated in at least FIGS. 17 and 21 (e.g., its first position), the outside release lever 136 is operated after the crash event or inertia causing event and when the outside release lever 136 is rotated in the direction of arrow 146 it resets the clutch lever 124. The clutch lever 124 in turn unclutches the inertia lever 120, thus inertia lever 120 returns to disengaged position by the help of spring 122.

During this movement the clutch lever 124 is rotated in a direction opposite to arrow 154 in the direction of arrow 155 and spring 122 provides a biasing force to the inertia lever 120 in the direction of arrow 157 so that the inertia lever 120 moves in a direction of arrow 139 opposite to arrow 138. When a force in the direction of arrow 146 is no longer applied to the outside release lever 136 the outside release lever 136 moves back to its first position, which is illustrated in at least FIG. 17. The outside release lever 136 is spring biased into its first position by for example a spring 178.

Thus, the inertia device 118 is reset and the outside release lever 136 is in its first position illustrated in at least FIGS. 16, 17 and 21. In these positions, the inertia device 118 is reset and the outside release lever 136 is in its first position and operation and release of the vehicle latch 110 through intended movement of the outside release lever 136 is possible and the inertia device 118 is also reset and capable of preventing inadvertent release of the vehicle latch through unintended movement of the outside release lever 136.

The term “about” is intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. An inertia device for a vehicle latch, comprising:
an inertia lever movably mounted to the vehicle latch for movement between a first position and a second position;
a clutch lever movably mounted to the vehicle latch for movement between a first position and a second position; and
a spring operably coupled to the inertia lever and the clutch lever, the spring biasing the inertial lever into its first position and the clutch lever into its second position, the inertia lever when in the first position prevents the clutch lever from moving to its second position and the clutch lever prevents the inertia lever from moving from its second position to its first position when the clutch lever is in its second position and movement of the inertial lever from its first position to its second position allows the clutch lever to move from its first position to its second position.

2. The inertia device as in claim 1, wherein the clutch lever has a first step portion for contacting a post of the inertia lever in order to retain the inertia lever in the first position.

3. The inertia device as in claim 2, wherein the clutch lever has a second step portion for contacting the post of the inertia lever in order to retain the inertia lever in its second position.

4. A vehicle latch, comprising:
an outside release lever movably mounted to a housing of the vehicle latch for movement between a first position and a second position, the second position of the outside release lever causing the vehicle latch to be in an unlatched condition;
an inertia device, the inertia device preventing undesired movement of the outside release lever from its first position to its second position, the inertia device comprising:
an inertia lever movably mounted to the housing for movement between a first position and a second position, the second position of the inertia lever preventing inadvertent movement of the outside release lever from its first position to its second position and the first position of the inertia lever allowing for desired movement of the outside release lever from its first position to its second position;
a clutch lever movably mounted to the housing for movement between a first position and a second position; and
a spring operably coupled to the inertia lever and the clutch lever, the spring biasing the inertial lever into its first position and the clutch lever into its second position, the inertia lever when in the first position prevents the clutch lever from moving to its second position from its first position and the clutch lever prevents the inertia lever from moving from its second position to its first position when the clutch lever is in its second position and movement of the inertial lever from its first position to its second position allows the clutch lever to move from its first position to its second position.

5. The vehicle latch as in claim 4, wherein the clutch lever has a first step portion for contacting a post of the inertia lever in order to retain the inertia lever in the first position.

6. The vehicle latch as in claim 5, wherein the clutch lever has a second step portion for contacting the post of the inertia lever in order to retain the inertia lever in its second position.

7. The vehicle latch as in claim 4, wherein the inertia lever has a pin slidably received within an opening of the outside release lever.

8. The vehicle latch as in claim 7, wherein the opening of the outside release lever has a first portion and a second portion, the first portion being connected to the second portion by a connecting portion, wherein movement of the inertia lever from its first position to its second position causes the pin to slide within the connecting portion of the opening.

9. The vehicle latch as in claim 8, wherein the first portion extends further from the connecting portion than the second portion and the first portion is an elongated opening configured to allow the pin to slid therein as the outside release lever from its first position to its second position.

10. The vehicle latch as in claim 9, wherein movement of the outside release lever from its first position to its second position is caused by actuation of an outside lever operably coupled to the outside release lever.

11. The vehicle latch as in claim 8, wherein the clutch lever has a first step portion for contacting a post of the inertia lever in order to retain the inertia lever in the first position.

12. The vehicle latch as in claim 11, wherein the clutch lever has a second step portion for contacting the post of the inertia lever in order to retain the inertia lever in its second position.

13. The vehicle latch as in claim 12, wherein the outside release lever has a cam surface that makes contact with the clutch lever when the clutch lever is in its second position and the outside release lever is moved from its first position to its second position.

14. The vehicle latch as in claim 13, wherein the outside release lever is spring biased into its first position by a spring.

15. The vehicle latch as in claim 4, wherein the outside release lever has a cam surface that makes contact with the clutch lever when the clutch lever is in its second position and the outside release lever is moved from its first position to its second position.

16. The vehicle latch as in claim 15, wherein the outside release lever is spring biased into its first position by a spring.

17. The vehicle latch as in claim 4, wherein the inertia lever has a stud pivotally mounted to a bushing of the housing and the clutch lever is rotationally mounted to a post of the housing.

18. The vehicle latch as in claim 4, wherein the outside release lever is spring biased into its first position by a spring.

19. An inertia device for a vehicle latch, comprising:
an inertia lever movably mounted to the vehicle latch for movement between a first position and a second position;
a clutch lever movably mounted to the vehicle latch for movement between a first position and a second position; and
a first spring operably coupled to the inertia lever, the first spring biasing the inertial lever into its first position;
a second spring operably coupled to the clutch lever, the second spring biasing the clutch lever into its second position, the inertia lever when in the first position prevents the clutch lever from moving to its second position and the clutch lever prevents the inertia lever from moving from its second position to its first position when the clutch lever is in its second position and movement of the inertial lever from its first position to its second position allows the clutch lever to move from its first position to its second position.
